(19) United States
(12) Patent Application Publication
(10) Pub. No.: US 2024/0097848 A1
(43) Pub. Date: Mar. 21, 2024

(54) REPORTING FREQUENCY AND DOPPLER PARAMETERS FOR COHERENT JOINT TRANSMISSION (CJT) AND MOBILITY

(71) Applicant: ZTE Corporation, Shenzhen (CN)

(72) Inventors: Bo GAO, Shenzhen (CN); Zhaohua LU, Shenzhen (CN); Meng MEI, Shenzhen (CN); Minqiang ZOU, Shenzhen (CN); Wenjun YAN, Shenzhen (CN)

(21) Appl. No.: 18/521,898

(22) Filed: Nov. 28, 2023

Related U.S. Application Data
(63) Continuation of application No. PCT/CN2022/111564, filed on Aug. 10, 2022.

(51) Int. Cl. H04L 5/00

(52) U.S. Cl. CPC H04L 5/0048; H04L 5/0023; H04L 5/0035; H04L 5/0057

(57) ABSTRACT

Disclosed are methods, systems, apparatuses, and computer readable media for generating a wireless device report for assisting a network node with frequency domain and time domain synchronization. In one aspect, a method of wireless communication is disclosed. The method includes receiving, at a wireless device, a report configuration associated with a reference signal (RS). The method further includes determining, at the wireless device, channel state information (CSI), wherein the CSI comprises at least one of an RS indicator, a rank indicator (RI), a precoding matrix indicator (PMI), Doppler information, or a channel quality index (CQI), according to the report configuration. The method includes reporting, at a wireless device, the channel state information (CSI).

### CROSS-REFERENCE TO RELATED APPLICATION

This application is a continuation and claims priority to International Application No. PCT/CN2022/111564, filed on Aug. 10, 2022, the disclosure of which is hereby incorporated by reference herein in its entirety.

### TECHNICAL FIELD

This patent document is directed to wireless communications

### BACKGROUND

In some wireless technologies including 5G new radio (NR), coherent joint transmission (CJT) is an emerging technique for obtaining an optimal performance for multi-user multiple input multiple output (MU-MIMO) devices using multiple transmission reception points (mTRP). For achieving CJT with a precoder across mTRP, the TRPs should be synchronous in frequency and in time. New synchronization techniques are needed.

### SUMMARY

Disclosed are methods, systems, apparatuses, and computer readable media for generating a wireless device report for assisting a network node with frequency domain and time domain synchronization. In one aspect, a method of wireless communication is disclosed. The method includes receiving, at a wireless device, a report configuration associated with a reference signal (RS). The method further includes determining, at the wireless device, channel state information (CSI), wherein the CSI comprises at least one of an RS indicator, a rank indicator (RI), a precoding matrix indicator (PMI), Doppler information, or a channel quality index (CQI), according to the report configuration. The method includes reporting, at a wireless device, the channel state information (CSI).

In another aspect, another wireless device is disclosed. The method includes sending, from a network node to a wireless device, a report configuration associated with a reference signal (RS), wherein channel state information (CSI) determined at the wireless device includes at least one of an RS indicator, a rank indicator (RI), a precoding matrix indicator (PMI), Doppler information, or a channel quality index (CQI), according to the report configuration, and wherein the wireless device reports the CSI to the network node.

### BRIEF DESCRIPTION OF THE DRAWINGS

FIG. 1 shows an example of multiple transmission reception points (mTRP) serving a single wireless device, in accordance with some example embodiments.

FIG. 2 shows an example of joint precoding across different TRPs for coherent joint transmission (CJT), in accordance with some example embodiments.

FIG. 3 shows an example of a reference signal (RS) configuration for a CJT channel status information (CSI) report, in accordance with some example embodiments.

FIG. 4 shows an example of a precoding assumption for CSI determination with the assistance of frequency parameters reported per resource group (e.g., TRP or TRP group), in accordance with some example embodiments.

FIG. 5 shows an example of a wireless device precoding assumption for CSI determination with the assistance of differential frequency parameters, in accordance with some example embodiments.

FIG. 6 shows example Doppler shifts per TRP for low/medium/high-speed wireless devices, in accordance with some example embodiments.

FIG. 7 shows an example of a co-phase information report for assisting phase-compensation across TRPs in CJT, in accordance with some example embodiments.

FIG. 8 shows an example of a RS configuration for Doppler-related measurement and report for medium/high-speed and CJT, in accordance with some example embodiments.

FIG. 9A shows an example of a process, in accordance with some example embodiments.

FIG. 9B shows another example of a process, in accordance with some example embodiments.

FIG. 10 shows an example of a system, in accordance with some example embodiments.

FIG. 11 shows an example of an apparatus, in accordance with some example embodiments.

### DETAILED DESCRIPTION

Section headings are used in the present document to improve readability and do not limit scope of the disclosed embodiments and techniques in each section to only that section. Certain features are described using 3GPP terminology but may be practices in other wireless systems that use other wireless communication protocols.

In some wireless technologies including 5G new radio (NR), coherent joint transmission (CJT) is an emerging technique for obtaining an optimal performance for multi-user multiple input multiple output (MU-MIMO) devices using multiple transmission reception points (mTRP). For achieving CJT with a precoder across mTRP, the TRPs should be synchronous in frequency and in time. In previous systems, the frequency synchronization may be broken due to Doppler introduced by wireless device (also referred to herein as UE or user equipment) mobility, and frequency synchronization issues related to the new base station (gNB) such as different center frequencies for different mTRP oscillators at different gNBs. Due to different propagation distances between the wireless devices and the TRPs, time-domain synchronization can be affected such as a delay larger than a cyclic prefix (CP) in an OFDM symbol, or a large delay spread. These may introduce a frequency selective fading that can degrade transmission performance.

For a normal channel status information (CSI) report (e.g., for sTRP), a time-domain channel property (e.g., Doppler shift and/or Doppler spread) can provide assistance information to the gNB to enable a refinement of the CSI reporting configuration (e.g., periodicity configuration for RS/CSI report), codebook configuration parameters (e.g., CSI codebook selection from CSI Type-I, CSI Type-II, CSI eType-II, etc.), and gNB-side CSI prediction.

The wireless device report procedure for assisting the gNB frequency domain and time domain synchronization are addressed herein, including for CJT. Specifically, the following issues are addressed herein:
1) For accommodating TRP in CJT CSI, phase-shift in frequency domain (e.g., frequency-domain (FD)-basis offset) and Doppler-domain difference (e.g., Doppler-domain (DD)-basis offset) across TRPs can be considered to be reported along with CSI for CJT (e.g., FD-basis selection or DD-basis-selection, or CQI).
2) For facilitating frequency synchronization or mitigating center frequency offsets across different TRPs, co-phase across CSI-RS for CSI (Port-selection or beam-formed CSI-RS)/TRS (corresponds to different TRPs) can be considered with low CSI report overhead. In such a case, the UE only need to provide co-phase information for mitigating phase shifting or phase noise across different TRPs for pre-compensation.
3) For supporting Doppler related measurement and reporting (e.g., Doppler shift (e.g., center frequency) or Doppler spread, which are also called as time-domain channel property in the medium/high-speed mobility scenario, RS configuration (e.g., based on tracking measurement signal (TRS) measurement) and report configuration is addressed herein. Specifically, whether/how this RS configuration or report configuration can be associated with parameters (e.g., codebook or precoding matrix indicator (PMI)) in another CSI measurement/report (e.g., typical CSI reporting or not), i.e., standalone vs. non-standalone is discussed.

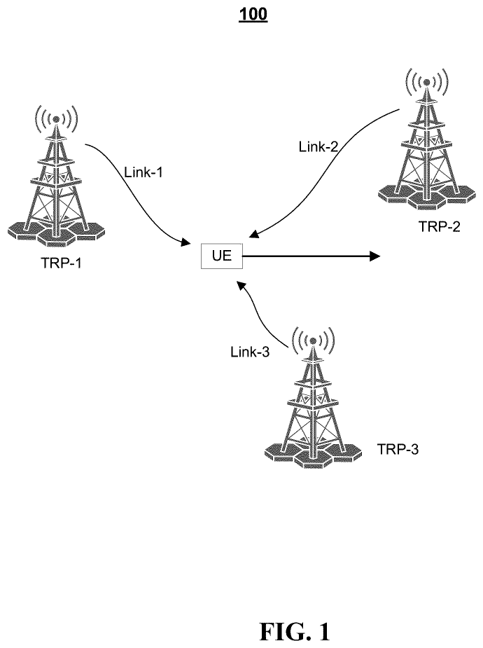

Because a massive or large-massive MIMO in a single TRP site can be expensive, multi-TRP operation is considered as a technique for balancing deployment cost and throughput/robustness. As shown in FIG. 1, an example for multi-TRP operation is provided accordingly. In such a case, especially for FDD or cell-edge UE in TDD, CSI information (involving PMI, RI, CQI, etc.) for determining DL precoder should be reported from UE to gNB, and even for a single layer (or a DMRS port) the precoder is provided across DL Tx antennas from respective mTRPs accordingly.

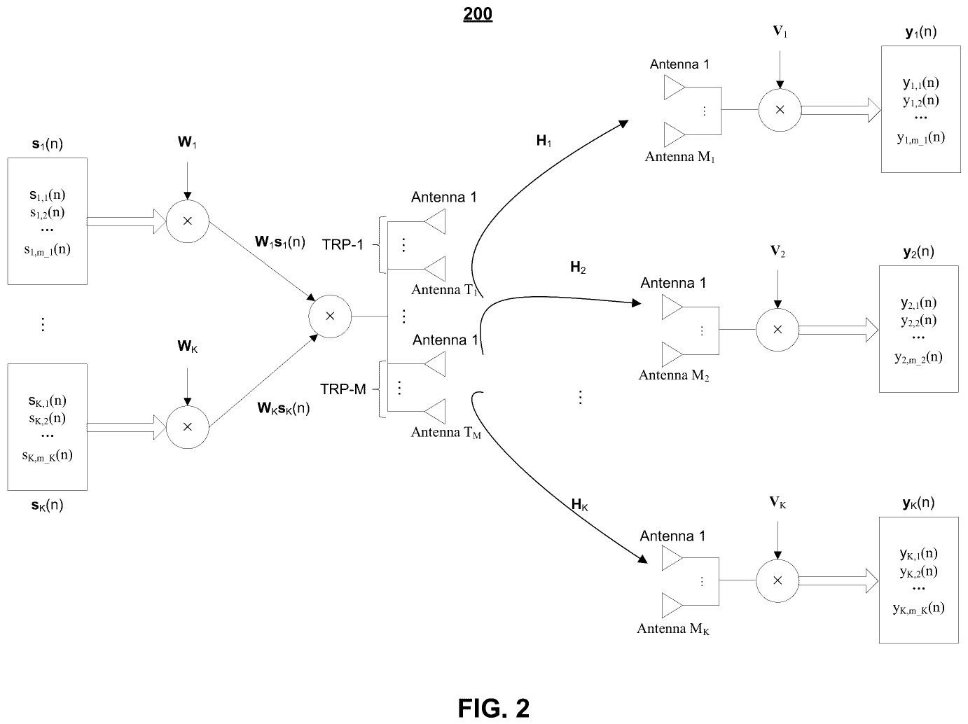

For MU-MIMO in CJT, we have the following diagram for depicting the transmission scheme as shown in FIG. 2. In order to achieve an ideal precoder, regardless of zero-forcing or SLNR mechanisms, the complete channel related information H is essential. That means that, besides for right eigenvector V in H, left eigenvector U and eigenvalue vector(s) are needed for reconstructing the channels accordingly. For SLNR, we have the following definition for UE-i:

$${SLNR}_{i} = \frac{Tr ( {W}_{i}^{H} {H}_{i}^{H} {H}_{i} {W}_{i} )}{Tr ( {W}_{i}^{H} ( {M}_{i} {σ}_{i}^{2} + {\tilde{H}}_{i}^{H} {\tilde{H}}_{i} ) {W}_{i} )}$$

where \tilde{H}ᵢ=[H₁ . . . Hᵢ₋₁ Hᵢ₊₁ . . . H_{K}], and Mᵢ denotes the number of Rx antenna(s) in UE-i. Then, for S-layer transmission for i-th UE, the precoding information is given by:

Wᵢ∝max·S eigenvectors((Mᵢσᵢ²+\tilde{H}ᵢ^{H}\tilde{H}ᵢ)⁻¹Hᵢ^{H}Hᵢ)

### EXAMPLES

Note that, in this patent document, the definition of “beam state” is equivalent to quasi-co-location (QCL) state, transmission configuration indicator (TCI) state, spatial relation (also called as spatial relation information), reference signal (RS), spatial filter or pre-coding. Furthermore, in this patent document, “beam state” is also called as “beam”. Specifically,
a) The definition of “Tx beam” is equivalent to QCL state, TCI state, spatial relation state, DL/UL reference signal (such as channel state information reference signal (CSI-RS), synchronization signal block (SSB) (which is also called as SS/PBCH), demodulation reference signal (DMRS), sounding reference signal (SRS), and physical random access channel (PRACH)), Tx spatial filter or Tx precoding;
b) The definition of “Rx beam” is equivalent to QCL state, TCI state, spatial relation state, spatial filter, Rx spatial filter or Rx precoding;
c) The definition of “beam ID” is equivalent to QCL state index, TCI state index, spatial relation state index, reference signal index, spatial filter index or precoding index.

Specifically, the spatial filter can be either UE-side or gNB-side one, and the spatial filter is also called as spatial-domain filter.

Note that in this patent document “spatial relation information” includes one or more reference RSs, which is used to represent the same or quasi-co “spatial relation” between targeted “RS or channel” and the one or more reference RSs.

Note that in this patent document a “spatial relation” means the beam, spatial parameter, or spatial domain filter.

Note that in this patent document “QCL state” includes one or more reference RSs and their corresponding QCL type parameters, where QCL type parameters include at least one of the following aspect or combination: [1] Doppler spread, [2] Doppler shift, [3] delay spread, [4] average delay, [5] average gain, and [6] Spatial parameter. In this patent document, “TCI state” is equivalent to “QCL state”. In this patent document, QCL type-D is equivalent to spatial parameter or spatial Rx parameter.

Note that in this patent document a “time unit” can be a sub-symbol, a symbol, a slot, a sub-frame, a frame, or a transmission occasion.

Note that in this patent document “DCI” can be equivalent to “PDCCH”.

Note that in this patent document ‘precoding information’ is equivalent to a PMI, TPMI, precoding or beam.

Note that in this patent document ‘TRP’ is equivalent to a RS port, a RS port group, RS resource, or a RS resource set.

Note that in this patent document ‘port group’ is equivalent to antenna group, or UE port group.

Note that in this patent document ‘transmission unit’ includes at least of one or more RE(s), one or more RB(s), one or more precoding resource group (PRGs), one or more subcarriers, one or more subband(s) or one or more frequency resources.

Note that in this patent document a ‘frequency offset’ is equivalent to frequency difference, or delay offset/shift.

Note that in this patent document a ‘transmission hypothesis’ is equivalent to CSI hypothesis, CSI mode, or CSI determined according to a combination of one or more RS port groups or RS resources.

Note that a ‘transmission resource group’ is equivalent to a beam state, a PCI, a CORESET group information, a CORESET pool ID, UE capability value set, a port, a port group, a RS resource or RS resource set. Note that the transmission resource group is also called as a resource group. Note that a ‘TRP’ is equivalent to the ‘transmission resource group’.

### Example 1: Reporting Frequency and Doppler Parameter for Facilitating CJT CSI

Generally, for CSI codebook/reporting for CJT, we firstly need to provide a mechanism of distinguishing different TRPs from one or more reference signals (RSs), like CSI-RS. Then, on the other hand, for interference measurement, non-zero-power (NZP) interference measurement resource (IMR) (NZP-IMR), i.e., a CSI-RS for interference measurement, or ZP-IMR should be configured.

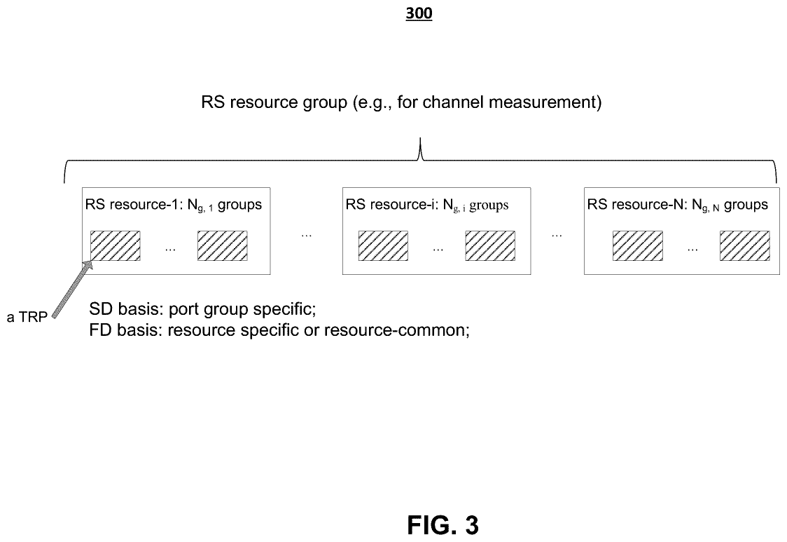

After receiving report configuration associated with reference signals (RSs), UE receives the reference signals according to the configuration, determines CSI, wherein the CSI comprises at least one of RI, PMI, and CQI, and then report CSI to gNB side.
For instance, one example for RS configuration for CJT is shown in FIG. 3, where each of port groups corresponds to a TRP (e.g., having an independent spatial domain (SD)-basis indication, as one portion of PMI). On the other hand, FD-basis (i.e., as another part of PMI) can be RS resource-specific or RS resource-common.

Due to different TRP-UE distance, e.g., 100 ns delay offset for a propagation-distance difference of 30 meters for different TRPs, the CJT transmission may experience a severe frequency-selective fading. Instead of reducing the size of subband or PRG, the pre-compensation of this phase shift (e.g., a frequency domain basis offset) in frequency domain (introduced by delay offset) per TRP may significantly improve the transmission performance.

For phase shift in the frequency domain across different TRPs (introduced by path/cluster-specific delay), the CSI can further comprises at least one of relative offset of FD-basis, or a frequency parameter (e.g., delay across different TRPs) for a transmission unit.
Furthermore, the indication of relative offset of FD-basis or frequency parameter is per resource group
Furthermore, the relative offset of FD-basis is based on a FD-basis corresponding to reference resource group.
   Furthermore, the reference resource group can be a first resource group (e.g., with a specific ID (e.g., 0), lowest or highest ID) from a set of resource groups corresponding to the CSI
   The relative offset can be an integer and/or a decimal (e.g., 0, 0.25, 0.5 or 0.75).
      For instance, if the relative offset is a decimal, it means that the FD-basis from different TRP may not be orthogonal.
   Applicable unit of a phase shift value in a FD-basis is based on a number of PRGs, RB(s) or sub-bands, which can be configured in CSI report configuration
   Furthermore, the indication FD-basis comprises a number of lists for FD basis (e.g., a window), and the relative offset corresponds to the list(s) (e.g., the difference between first FD-basis of different lists).
      The list of FD-basis can be indicated by a bitmap, where the size of bitmap is determined according to the number of FD-basis. Then, when a bit of bitmap is a specific value, e.g., ‘1’, the corresponding FD-basis is selected.
The frequency parameter is to indicate additional FD-basis or phase shift vector for resource group (e.g., one or more FD-basis, or antenna ports (e.g., PDSCH)). For instance, the frequency parameter is layer-common and antenna port (group)-specific, and co-phase shifting for a given transmission unit (e.g., a plurality of RE(s) or RB(s)). From the perspective of physical channel, it is relevant to the delay of first or dominant physical path.
   Furthermore, the CSI (e.g., CQI) is determined according to the frequency parameter, which means that, for determining CSI, UE should assume the corresponding CSI if the corresponding antenna port(s) is compensated according to the frequency parameter.
      Furthermore, for CQI, RI and/or PMI determination, the PDSCH on antenna ports in the set [1000, . . . , 1000+v−1] for v layer would result in signals equivalent to corresponding symbols transmitted on antenna ports [3000, . . . , 3000+P−1], as given by

$$[ \begin{matrix}{y}^{( 3000 )} ( i ) \\ … \\ {y}^{( 3000 + P - 1 )} ( i )\end{matrix} ] = Q ( i ) W ( i ) [ \begin{matrix}{x}^{( 0 )} ( i ) \\ … \\ {x}^{( v - 1 )} ( i )\end{matrix} ] ,$$

where

$$[ \begin{matrix}{x}^{( 0 )} ( i ) \\ … \\ {x}^{( v - 1 )} ( i )\end{matrix} ]$$

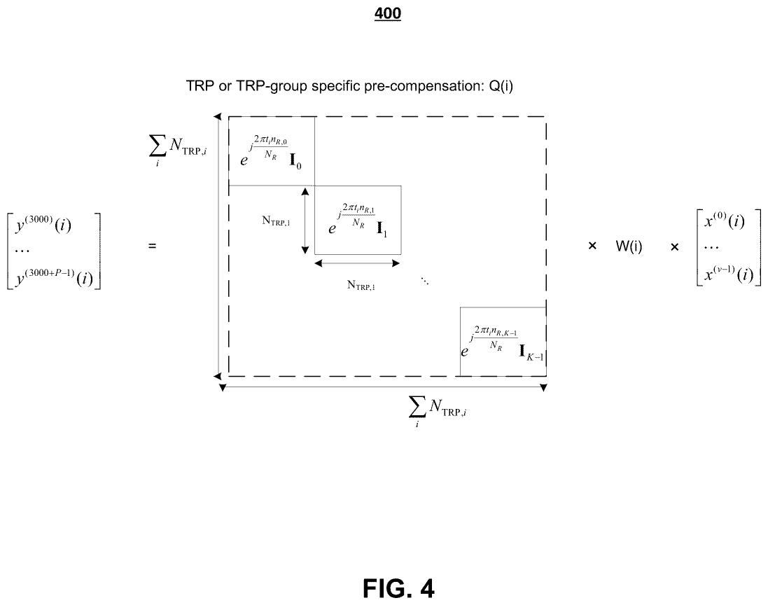

is a vector of PDSCH symbols from layer mapping, W(i) is the precoding matrix corresponding to CSI, Q(i) is a matrix determined according to the frequency parameter and P is the number of CSI-RS ports.
For instance, one example of Q(i) and the proposed precoding scheme can be found in FIG. 4.
Furthermore, for a given transmission unit (e.g., RE, RB or subband)−tᵢ (tᵢ=0,1,2, . . . , N_{R}−1), (i.e., a transmission unit tᵢ for a given symbol-i for PDSCH), Q is given by

$$diag ( {\underbrace{{e}^{j \frac{2 π {t}_{i} {n}_{R , 0}}{{N}_{R}}} , … , {e}^{j \frac{2 π {t}_{i} {n}_{R , 0}}{{N}_{R}}}}}_{{N}_{TRP , 0}} , {\underbrace{{e}^{j \frac{2 π {t}_{i} {n}_{R , 1}}{{N}_{R}}} , … , {e}^{j \frac{2 π {t}_{i} {n}_{R , 1}}{{N}_{R}}}}}_{{N}_{TRP , 1}} , … , {\underbrace{{e}^{j \frac{2 π {t}_{i} {n}_{R , K - 1}}{{N}_{R}}} , … , {e}^{j \frac{2 π {t}_{i} {n}_{R , K - 1}}{{N}_{R}}}}}_{{N}_{TRP , K - 1}} ) ,$$

where N_{R} and n_{R,x} denotes the number of transmission unit(s), and frequency parameter for x-th resource group, respectively.
Furthermore, the number of resource(s) or a unit of resource (e.g., the number of REs or RB s) is configured by gNB.
Furthermore, a number of transmission units or a resource in a transmission unit is configured by a RRC or MAC-CE command.
Furthermore, the total number of resource groups (i.e., transmission resource groups or TRPs) is K.
Furthermore, the precoding matrix for a transmission unit is determined according to

$${e}^{j \frac{2 π {t}_{i} {n}_{R , x}}{{N}_{R}}} ,$$

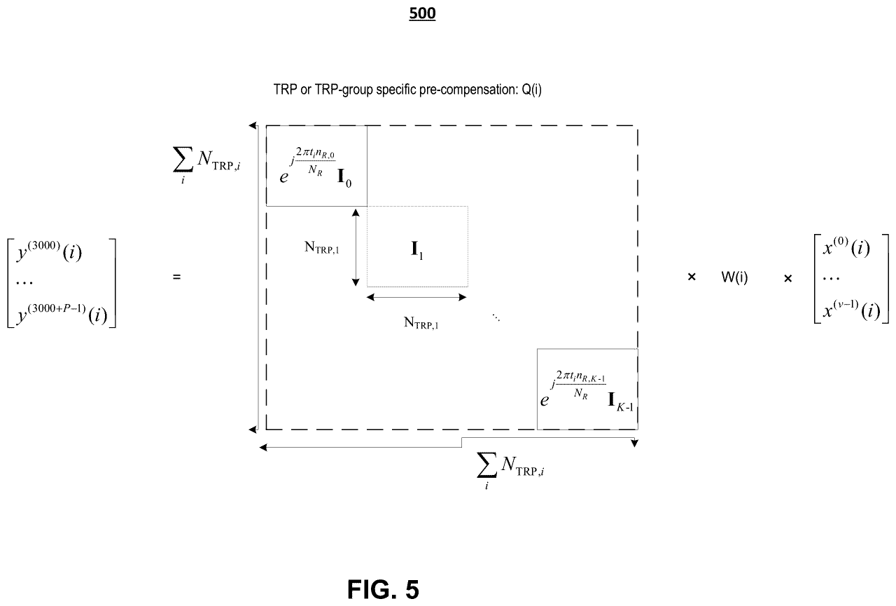

SD-basis and FD-basis, where N_{R} and n_{R,x} denotes the number of transmission unit(s), and frequency parameter for x-th resource group, respectively.
For instance, the precoding matrix across all mTRP for CJT in the CSI report can be represented as follows.

$$W = [ \begin{matrix}{e}^{j \frac{2 π {t}_{i} {n}_{R , 0}}{{N}_{R}}} {w}_{0} \\ {e}^{j \frac{2 π {t}_{i} {n}_{R , 1}}{{N}_{R}}} {w}_{1} \\ ⋮ \\ {e}^{j \frac{2 π {t}_{i} {n}_{R , x}}{{N}_{R}}} {w}_{x} \\ ⋮ \\ {e}^{j \frac{2 π {t}_{i} {n}_{R , K - 1}}{{N}_{R}}} {w}_{K - 1}\end{matrix} ]$$

where precoding matrix wₓ denotes x-th TRP related precoding matrix (i.e., without considering the frequency parameter of n_{R,x}).
Furthermore, the frequency parameter is layer-common and/or port/port-group specific.
   Furthermore, the frequency parameter is a differential value over a reference resource group.
      Furthermore, for reference resource group, the frequency parameter is 1, and then a list of frequency parameters are reported in the CSI and correspond to the rest of one or more of resource group by order.
      In such case, as shown in FIG. 5 for example, the frequency parameter corresponding to the x-th resource group (e.g., for x=2, i.e., second TRP) is an identify matrix. In other words, for instance, the precoding matrix across all mTRP for CJT in the CSI report can be represented as follows.

$$W = [ \begin{matrix}{e}^{j \frac{2 π {t}_{i} {n}_{R , 0}}{{N}_{R}}} {w}_{0} \\ {w}_{1} \\ ⋮ \\ {e}^{j \frac{2 π {t}_{i} {n}_{R , x}}{{N}_{R}}} {w}_{x} \\ ⋮ \\ {e}^{j \frac{2 π {t}_{i} {n}_{R , K - 1}}{{N}_{R}}} {w}_{K - 1}\end{matrix} ]$$

Furthermore, the reference resource group can be indicated in the CSI (e.g., up to 2 bit for identifying up to 4 TRPs/resource groups).
For instance, the frequency parameter is applied to all layer but one or more port/port-group.
Furthermore, the resource group comprises at least one of beam state, PCI, CORESET group information, CORESET pool ID, UE capability value set, a port, a port group, a RS resource or RS resource set.
   For instance, port group comprises at least one of RS port group (e.g., CSI-RS or SRS port group) or antenna port groups.

### Example 2: Co-phase Measurement and Report for Assisting Phase-compensation Across TRPs in CJT

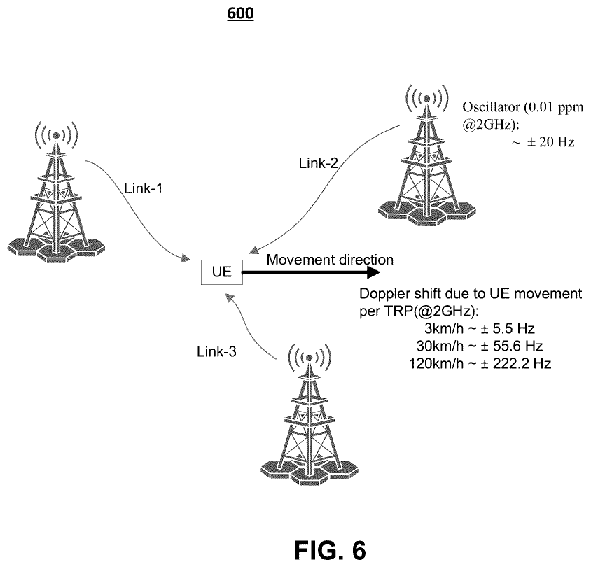

Additionally, besides for different average delay (due to different TRP-UE distance, e.g., 100 ns delay offset for a propagation-distance difference of 30 meters for different TRPs), frequency offset (due to TRP-specific oscillator difference) and Doppler shift introduced by UE mobility may be much more severe than center frequency offsets from the gNB oscillator. For Doppler shift, one example can be found in FIG. 6.
For instance, when UE speed is 30 km/h (as in a vehicle in dense urban), Doppler shift may be up to 55.6 Hz for a TRP, and then in such case, for 10 ms (a typical periodicity of CSI report), up to 200.16 degree phase-error may be experienced. That means that a severe performance degradation may occur for CJT.

In a word, even though ignoring the in-sync issues from CJT-TRP, we still need to handle frequency domain difference(s) across TRPs.

For handling frequency offset (introduced by center frequency difference across different TRP or path/cluster-specific delay), the CSI can further provide co-phase information with low RS and report overhead, besides for Doppler shift related report (that will be discussed in Embodiment #3).
Furthermore, CSI comprises co-phase information across different CSI-RS ports or resources (e.g., CSI-RS for tracking)
   The co-phase information can be wideband or subband.
   The co-phase information can be reported in a different manner.
      Furthermore, the co-phase for first resource group can be assumed as 1 or ignored, and then the co-phase for other resource group is based on the first resource group.
   Furthermore, the co-phase may be determined according to respective UE Rx precoder for reception, and so the CSI reference resource for co-phase determination can be assumed based on another CSI measurement/report.
      Furthermore, the CSI report configuration for co-phase report can be associated with anther CSI report configuration.
      Furthermore, the ports for co-phase determination correspond to a given layer or precoder.
         Furthermore the layer or precoder is determined by associated CSI or associated RS.
         For instance, the layer corresponds to the a given layer (e.g., first layer or a layer with a specific index (e.g., 0, lowest index or highest index)) or layer indicated by LI in the latest CSI report (for CJT)
         For instance, under a given layer/precoding, UE report the co-phase for ports or phase-difference/ratio compared with the reference port (e.g., based on reference corresponds to the first layer or layer indicated by LI in latest CJT report).
      Furthermore, in the case of having more than one layer, the CSI-RS with a plurality of CSI-RS port) or more than one CSI-RS resources can be configured in such case.
         Then, each of ports with same port index from respective resource groups corresponds to a same layer.
         Or, the co-phase is determined according to the ports with the same port index from respective CSI-RS resource.
      Furthermore, a list of co-phase(s) are provided for respective resource groups.

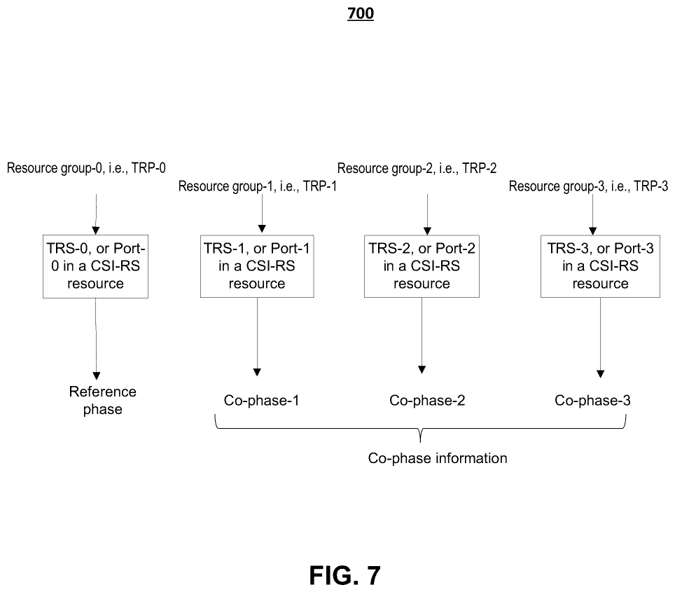

For instance, there are several TRSs (a single port for one TRS), each of which is associated with resource group. Then, the UE should use the corresponding precoder or a single port for determined the co-phase information. The corresponding precoder refers to a precoder used for one CSI mode (e.g., RANK=1 transmission) or transmission hypothesis in which the corresponding resource group performed.
One example for co-phase information report for assisting phase-compensation across TRPs is shown in FIG. 7. In such case, there are four TRS resource set (only one port for a set) or four CSI-RS ports (in a resource), each of which corresponds to respective resource group. The co-phase information over the first TRS -0 for the rest TRS(s) is provided in the CSI. After receiving this information, the TRP can compensate their Tx phase offset accordingly.
For saving CSI report overhead, only co-phase information is carried in this case, which means that we have a new report quantity of ‘co-phase’.

### Example 3: Doppler-related Measurement and Report in Medium/High-speed and CJT

Besides for co-phase information report, Doppler-related measurement and report may be suitable for handling in-sync issue cross different TRPs in frequency domain with efficient. Besides, for medium and high-speed mobility, Doppler shift and Doppler spread information is also very useful for determining CSI codebook type and CSI-RS/CSI report periodicity.
Furthermore, the CSI report comprises Doppler related information (e.g., frequency offset, Doppler shift and Doppler spread), which corresponds to RS resource or RS resource set.
   Furthermore, the Doppler related information is UE-specific, SD-basis-specific, or layer-specific.
   Furthermore, the CSI report comprises RS resource ID or RS resource set ID. Technically speaking, TRS is configured per resource-set, and so RS resource set ID may indicate this information clearly.
   Furthermore, the first Doppler related information is reported by an absolute value (e.g., largest or lowest measured value), and then the rest Doppler related information is reported by a differential value corresponding to the first one.
Furthermore, in a resource setting, more than one TRS resource sets can be configured.
   Furthermore, above is applied to periodic and semi-persistent CSI report.
Furthermore, in a triggering state, more than one TRS resource sets can be associated with a reporting configuration, e.g., explicit ID or by a bitmap.
Furthermore, at least one of the following is reported in UE capability signaling for accommodating this Doppler related report:
   The number of TRS resource sets to be measured in a CC or across a plurality of CC (e.g., in a band),
   The number of TRS resources to be measured in a CC or across a plurality of CC (e.g., in a band),
   The maximum number of TRS resource sets can be configured in a resource setting or for a report, or
   The supported report quantities, e.g., Doppler shift, Doppler spread, relative value of Doppler shift corresponding to different TRSs.
Furthermore, the TRS resource set or resource setting can be associated with one or more resource groups.
Furthermore, the reporting configuration can be associated with another report configuration (e.g., for CJT)
   Furthermore, some parameter(s) in the reporting configuration can be determined according to another report configuration.
   Furthermore, the Doppler related information is determined according to the codebook or PMI in another CSI measurement/report.
      For instance, the UE Rx precoder corresponding to the PMI is used for determining Doppler related information.

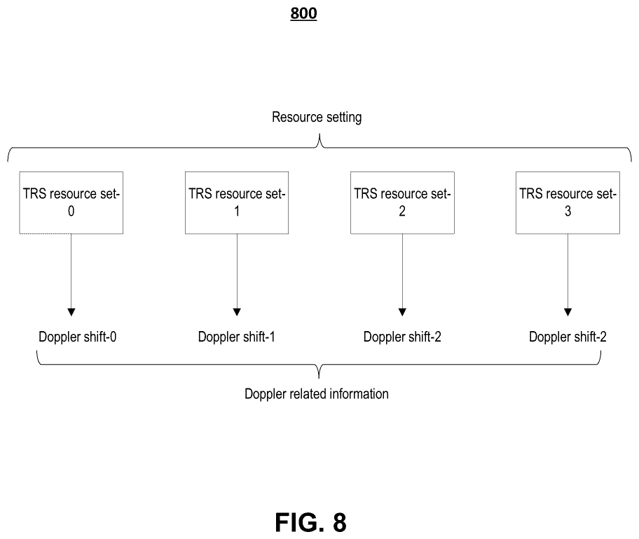

For instance, one example for RS configuration for Doppler-related measurement and report in medium/high-speed and CJT can be found in FIG. 8. In one resource setting, more than one TRS resource set can be configured, and the corresponding Doppler shift can be reported per TRS resource set. For saving the reporting overhead, the Doppler related report configuration can be associated with another CSI for CJT, and only the Doppler related parameter corresponding to the reported CRI in the last report need to be reported.

In this disclosure, for accommodating TRP in CJT CSI, CSI report mechanism of frequency-domain and Doppler-domain difference across TRPs are proposed to be reported along with CSI for CJT (e.g., FD-basis selection or DD-basis-selection, or CQI). Then, co-phase measurement and report cross one or more CSI-RS (e.g., TRS) are recommended for mitigating the phase shifting/noise across different TRPs for compensation. After that, for supporting Doppler related measurement and report in medium/high-speed mobility scenario, RS configuration (e.g., based on TRS measurement) and report configuration are specified, including the enhancement that RS or report configuration or CSI determination can be associated with parameters (e.g., codebook or PMI) in another CSI measurement/report.

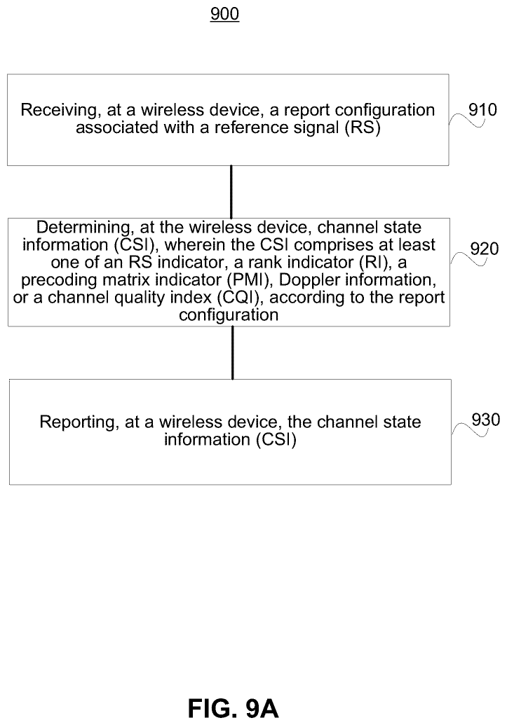

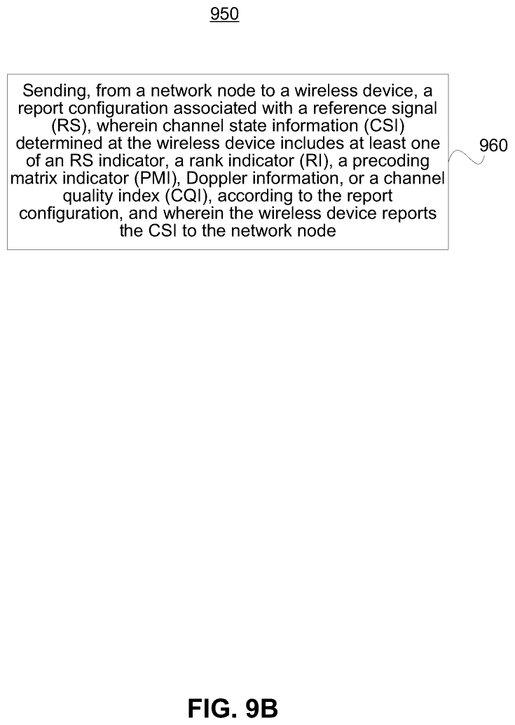

FIG. 9A depicts an example of a method of wireless communication 900, in accordance with some example embodiments. At 910, the method includes receiving, at a wireless device, a report configuration associated with a reference signal (RS). At 920, the method includes determining, at the wireless device, channel state information (CSI), wherein the CSI comprises at least one of an RS indicator, a rank indicator (RI), a precoding matrix indicator (PMI), Doppler information, or a channel quality index (CQI), according to the report configuration. At 930, the method includes reporting, at a wireless device, the channel state information (CSI).

FIG. 9B depicts an example of a method of wireless communication 950, in accordance with some example embodiments. At 960, the method includes sending, from a network node to a wireless device, a report configuration associated with a reference signal (RS), wherein channel state information (CSI) determined at the wireless device includes at least one of an RS indicator, a rank indicator (RI), a precoding matrix indicator (PMI), Doppler information, or a channel quality index (CQI), according to the report configuration, and wherein the wireless device reports the CSI to the network node

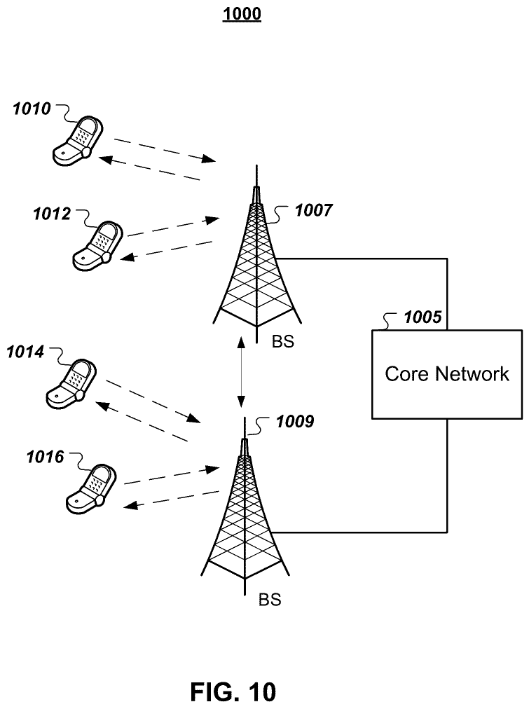

FIG. 10 shows an example of a wireless communication system (e.g., a 5G or NR cellular network) that includes one or more base stations 1007, 1009 and one or more user equipment (UE) 1010, 1012, 1014 and 1016. In some embodiments, the UEs access the BS and core network 1005 (e.g., the network) using a communication link to the network (sometimes called uplink direction, as depicted by dashed arrows pointing toward a base station), which then enables subsequent communication. In some embodiments, the BS sends information to the UEs (sometimes called downlink direction, as depicted by arrows from the base stations to the UEs), which then enables subsequent communication between the UEs and the BSs, shown by dashed arrows between the UEs and the BSs.

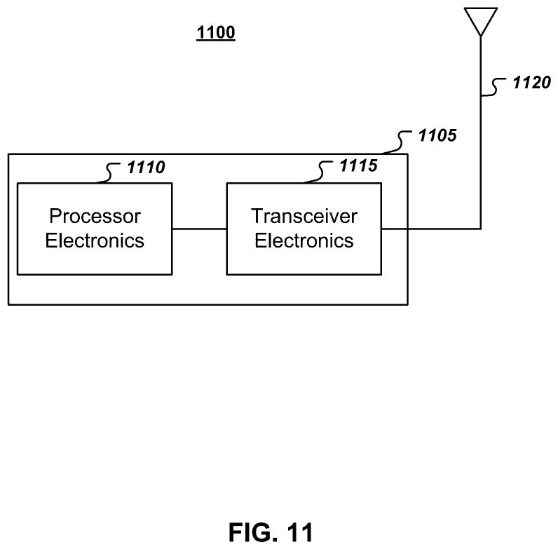

FIG. 11 shows an exemplary block diagram of a hardware platform 1100 that may be a part of a network node (e.g., base station) or a communication device (e.g., a wireless device such as a user equipment (UE)). The hardware platform 1100 includes at least one processor 1110 and a memory 1105 having instructions stored thereupon. The instructions upon execution by the processor 1110 configure the hardware platform 1100 to perform the operations described in FIGS. 1 to 9 in the various embodiments described in this patent document. The transceiver 1115 transmits or sends information or data to another device. For example, a wireless device transmitter as part of transceiver 1115 can send a message to a user equipment via antenna 1120. The transceiver 1115 receives information or data transmitted or sent by another device via antenna 1120. For example, a wireless device receiver as part of transceiver 1115 can receive a message from a network device via antenna 1120.

### The Following Clauses Reflect Features of Some Preferred Embodiments

Clause 1. A method of wireless communication, comprising: receiving, at a wireless device, a report configuration associated with a reference signal (RS); determining, at the wireless device, channel state information (CSI), wherein the CSI comprises at least one of an RS indicator, a rank indicator (RI), a precoding matrix indicator (PMI), Doppler information, or a channel quality index (CQI), according to the report configuration; and reporting, at a wireless device, the channel state information (CSI).

Clause 2. The method of wireless communication of clause 1, wherein the CSI comprises an indication of a relative offset between frequency domain (FD) bases, or a frequency parameter, or a precoding matrix is determined according to a relative offset between frequency domain (FD) bases, or a frequency parameter.

Clause 3. The method of wireless communication of clause 2, wherein one or more of: the frequency parameter includes at least one of: a FD basis, a frequency offset, a ratio of phase difference, a phase shift vector, or a delay offset, the relative offset or the frequency parameter is determined across a plurality of transmission resource groups, the relative offset is an integer value or a decimal value, or the relative offset or the frequency parameter corresponds to at least one of: a transmission unit, or a transmission resource group.

Clause 4. The method of wireless communication of clause 2, wherein the indication of the relative offset of FD-basis or the frequency parameter is associated with one transmission resource group.

Clause 5. The method of wireless communication of clause 2, wherein the relative offset of FD-basis, or the frequency parameter corresponds to a reference transmission resource group.

Clause 6. The method of wireless communication of clause 5, wherein the reference transmission resource group comprises at least one of: a first transmission resource group with a lowest frequency basis, a first transmission resource group with a lowest frequency parameter, a first transmission resource group with a strongest coefficient, or a first transmission resource group with a specific identity, or a lowest or a highest identity from a set of transmission resource groups.

Clause 7. The method of wireless communication of clause 2 or 3, wherein a phase shift value in a FD-basis is based on a number of transmission units, precoding resource groups (PRGs), resource blocks (RBs), resource elements (REs), or sub-bands which are configured in a CSI report configuration.

Clause 8. The method of wireless communication of clause 2, wherein the FD-basis comprises a number of lists of FD bases, and wherein the relative offset corresponds to a difference between first FD-bases of different lists.

Clause 9. The method of wireless communication of clause 8, wherein the list of FD-bases is indicated by a bitmap, where a size of the bitmap is determined according to the number of FD-bases, the list of FD-bases is indicated by a combinatorial number, or the list of FD-bases is indicated by an index of a starting FD basis and the size of the list.

Clause 10. The method of wireless communication of clause 2, wherein at least one of the RS indicator, RI, PMI or CQI in the CSI is determined according to the frequency parameter.

Clause 11. The method of wireless communication of clause 10, wherein the at least one of the RS indicator, RI, PMI or CQI is determined under the assumption that a corresponding antenna port is compensated according to the frequency parameter.

Clause 12. The method of wireless communication of clause 10, wherein for the RI, PMI or CQI determination, the shared channel on antenna ports for a v layer results in signals equivalent to corresponding symbols transmitted on a P antenna ports, as expressed by: Y(i)=Q(i)W(i)X(i), wherein X(i) is a vector of shared channel symbols with a length of v, W(i) is a precoding matrix, Q(i) is a matrix determined according to the frequency parameter and Y(i) is a vector of symbols with a length of P.

Clause 13. The method of wireless communication of clause 12, wherein tᵢ=0, 1, 2, . . . , N_{R}−1, Q(i) is expressed as:

$$diag ( {e}^{j \frac{2 π {t}_{i} {n}_{R , 0}}{{N}_{R}}} , … , {e}^{j \frac{2 π {t}_{i} {n}_{R , 0}}{{N}_{R}}} , {e}^{j \frac{2 π {t}_{i} {n}_{R , 1}}{{N}_{R}}} , … , {e}^{j \frac{2 π {t}_{i} {n}_{R , 1}}{{N}_{R}}} , … , {e}^{j \frac{2 π {t}_{i} {n}_{R , K - 1}}{{N}_{R}}} , … , {e}^{j \frac{2 π {t}_{i} {n}_{R , K - 1}}{{N}_{R}}} ) ,$$

where N_{R} and n_{R,x} denotes a number of transmission units and a frequency parameter for an x-th transmission resource group, respectively.

Clause 14. The method of wireless communication of clause 2, wherein the relative offset or the frequency parameter is associated with a transmission unit, and wherein a number of transmission units or a resource in a transmission unit is configured by a RRC or MAC-CE command.

Clause 15. The method of wireless communication of clause 2, wherein the precoding matrix for a transmission unit is determined according to

$${e}^{j \frac{2 π {t}_{i} {n}_{R , x}}{{N}_{R}}} ,$$

a SD-basis or a FD-basis, where N_{R} and n_{R,x} denote a number of transmission units and a frequency parameter for an x-th transmission resource group, respectively, and wherein tᵢ=0,1,2, . . . , N_{R}−1.

Clause 16. The method of wireless communication of clause 2, wherein the frequency parameter is at least one of layer-common, port specific, port-group specific or RS resource specific.

Clause 17. The method of wireless communication of clause 2, wherein the frequency parameter is a differential value over a reference transmission resource group.

Clause 18. The method of wireless communication of clause 17, wherein for the reference transmission resource group, the frequency parameter is 1 or predefined, and a list of frequency parameters is reported in the CSI and corresponds to the rest of the one or more of transmission resource groups by order.

Clause 19. The method of wireless communication of clause 1, wherein the CSI comprises co-phase information across different ports, port groups or RS resources, or a precoding matrix is determined according to co-phase information across different ports, port groups or RS resources.

Clause 20. The method of wireless communication of clause 19, wherein the co-phase information is wideband or subband information, the co-phase information for a first transmission resource group is assumed as 1 or ignored, the co-phase information for another transmission resource group is based on the first transmission resource group, the co-phase information is determined according to a respective beam state or a respective wireless device precoder for reception, or a CSI reference resource for co-phase determination is assumed based on another CSI measurement or report.

Clause 21. The method of wireless communication of clause 19, wherein the report configuration for co-phase information is associated with another CSI report configuration.

Clause 22. The method of wireless communication of clause 19, wherein ports for co-phase determination correspond to a given layer or precoder.

Clause 23. The method of wireless communication of clause 22, wherein the layer or precoder is determined by an associated CSI or an associated RS.

Clause 24. The method of wireless communication of clause 22, wherein the RS with a plurality of RS ports or more than one RS resource is configured.

Clause 25. The method of wireless communication of clause 23, wherein each port with a same port index from respective resource groups corresponds to a same layer.

Clause 26. The method of wireless communication of clause 19, wherein the co-phase information is determined according to ports with a same port index from respective RS resources.

Clause 27. The method of wireless communication of clause 19, wherein a list of co-phases is provided for respective transmission resource groups.

Clause 28. The method of wireless communication of clause 1, wherein the CSI report comprises Doppler information including one or more of a frequency offset, a Doppler shift or a Doppler spread, and wherein the Doppler information is determined according to one or more RS resources or one or more RS resource sets.

Clause 29. The method of wireless communication of clause 28, wherein the Doppler information is wireless device specific, spatial domain (SD)-basis-specific, or layer-specific.

Clause 30. The method of wireless communication of clause 1, wherein the RS indicator comprises an RS resource identity or a RS resource set identity.

Clause 29. The method of wireless communication of clause 28, wherein one or more of the Doppler information is reported as a differential value compared to the first Doppler information in the CSI report.

Clause 30. The method of wireless communication of clause 29, wherein the first Doppler information corresponds to a largest or lowest measured Doppler information.

Clause 31. The method of wireless communication of clause 1, wherein the RS comprises one or more tracking reference signal (TRS) resources or resource sets indicated by an identity list or a bitmap.

Clause 32. The method of wireless communication of clause 31, wherein the bitmap indicates the TRS resource sets from a list of TRS resource sets.

Clause 33. The method of wireless communication of clause 28, wherein at least one of the following is reported in a wireless device capability signaling: a number of TRS resource sets measured in a component carrier (CC) or across a plurality of CCs, a number of TRS resources measured in a CC or across the plurality of CCs, a maximum number of TRS resource sets configured in a resource setting or for a report, or a supported CSI report including one or more of Doppler shift, Doppler spread, or relative value of Doppler shift corresponding to different TRSs.

Clause 34. The method of wireless communication of clause 28, wherein a TRS resource set or resource setting is associated with one or more resource group.

Clause 35. The method of wireless communication of clause 28, wherein the reporting configuration is associated with another report configuration.

Clause 36. The method of wireless communication of clause 28, wherein at least one parameter in the reporting configuration is determined according to another report configuration.

Clause 37. The method of wireless communication of clause 28, wherein the Doppler information is determined according to a codebook or a PMI in another CSI measurement or report.

Clause 38. The method of wireless communication of any of clauses 1 to 37, wherein the transmission resource group comprises a beam state, a physical cell identity (PCI), a control resource set (CORESET) group information, a CORESET pool identity, a wireless device capability value set, a port, a port group, a RS resource, or RS resource set.

Clause 39. A method of wireless communication, comprising: sending, from a network node to a wireless device, a report configuration associated with a reference signal (RS), wherein channel state information (CSI) determined at the wireless device includes at least one of an RS indicator, a rank indicator (RI), a precoding matrix indicator (PMI), Doppler information, or a channel quality index (CQI), according to the report configuration, and wherein the wireless device reports the CSI to the network node.

Clause 40. The method of wireless communication of clause 39, wherein the CSI comprises co-phase information across different ports, port groups or RS resources, or a precoding matrix is determined according to co-phase information across different ports, port groups or RS resources.

Clause 41. The method of wireless communication of clause 39, wherein the CSI report comprises Doppler information including one or more of a frequency offset, a Doppler shift or a Doppler spread, and wherein the Doppler information is determined according to one or more RS resource or one or more RS resource set.

Clause 42. A wireless communication apparatus, comprising a processor configured to implement a method recited in any one or more of clauses 1 to 41.

Clause 43. A computer program product having code stored thereon, the code, when executed by a processor, causing the processor to implement a method recited in any one or more of clauses 1 to 41.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A method of wireless communication, comprising:
receiving, at a wireless device, a report configuration associated with a reference signal (RS);
determining, at the wireless device, channel state information (CSI), wherein the CSI comprises at least one of an RS indicator, a rank indicator (RI), a precoding matrix indicator (PMI), Doppler information or a channel quality index (CQI), according to the report configuration; and
reporting, at a wireless device, the channel state information (CSI).

2. The method of wireless communication of claim 1, wherein
the CSI comprises an indication of a relative offset between frequency domain (FD) bases, or a frequency parameter, or
wherein the frequency parameter is at least one of layer-common, or RS resource specific.

3. The method of wireless communication of claim 2, wherein one or more of:
the frequency parameter includes at least one of: a frequency offset, or a phase shift vector,
the relative offset or the frequency parameter is determined across a plurality of RS resources,
the relative offset is an integer value or a decimal value, or
the relative offset or the frequency parameter corresponds to a RS resource.

4. The method of wireless communication of claim 2, wherein the indication of the relative offset of FD-basis, or the frequency parameter is associated with one RS resource.

5. The method of wireless communication of claim 2,
wherein the relative offset of FD-basis corresponds to a reference RS resource, and
wherein the reference RS resource comprises a first RS resource with a specific identity, or a lowest identity from a set of RS resources.

6. The method of wireless communication of claim 2, wherein the FD-basis comprises a number of lists of FD bases, and wherein the relative offset corresponds to a difference between first FD-bases of different lists.

7. The method of wireless communication of claim 1, wherein the at least one of the RS indicator, the RI, the PMI or the CQI is determined under the assumption that a corresponding antenna port is compensated according to the frequency parameter.

8. The method of wireless communication of claim 2, wherein the relative offset or the frequency parameter is associated with a transmission unit, and wherein a number of transmission units or a resource in a transmission unit is configured by a RRC or MAC-CE command.

9. The method of wireless communication of claim 2, wherein a precoding matrix for a transmission unit is determined according to
$${e}^{j \frac{2 π {t}_{i} {n}_{R , x}}{{N}_{R}}} ,$$
a SD-basis or a FD-basis, where N_{R} and n_{R,x} denote a number of transmission units and a frequency parameter for an x-th RS resource, respectively, and wherein tᵢ=0,1,2, . . . , N_{R}−1.

10. The method of wireless communication of claim 2,
wherein the frequency parameter is a differential value over a reference RS resource, and
wherein for the reference RS resource, the frequency parameter is predefined, and a list of frequency parameters is reported in the CSI and corresponds to the rest of the one or more of RS resources by order.

11. The method of wireless communication of claim 9, wherein a precoding matrix is determined according to
$${e}^{j \frac{2 π {t}_{i} {n}_{R , K}}{{N}_{R}}} {w}_{K} ,$$
wherein N_{R} and n_{R,x} denote a number of transmission units and a frequency parameter for a K-th RS resource, respectively, wherein tᵢ=0,1,2, . . . , N_{R}−1, and wherein K is a K-th RS resource.

12. The method of wireless communication of claim 10, wherein the reference RS resource is indicated in the CSI.

13. A method of wireless communication, comprising:
transmitting, by a network device, a report configuration associated with a reference signal (RS); and
receiving, by the network device, a channel state information (CSI), wherein the CSI comprises at least one of an RS indicator, a rank indicator (RI), a precoding matrix indicator (PMI), Doppler information or a channel quality index (CQI), according to the report configuration.

14. The method of wireless communication of claim 13,
wherein the CSI comprises an indication of a relative offset between frequency domain (FD) bases, or a frequency parameter, or
wherein the frequency parameter is at least one of layer-common, or RS resource specific.

15. The method of wireless communication of claim 14, wherein one or more of:
the frequency parameter includes at least one of: a frequency offset, or a phase shift vector,
the relative offset or the frequency parameter is determined across a plurality of RS resources,
the relative offset is an integer value or a decimal value, or
the relative offset or the frequency parameter corresponds to a RS resource.

16. The method of wireless communication of claim 14, wherein the indication of the relative offset of FD-basis, or the frequency parameter is associated with one RS resource.

17. A wireless communication apparatus, comprising a processor configured to implement a method, the processor configured to:
receive, at a wireless device, a report configuration associated with a reference signal (RS);
determine, at the wireless device, channel state information (CSI), wherein the CSI comprises at least one of an RS indicator, a rank indicator (RI), a precoding matrix indicator (PMI), Doppler information or a channel quality index (CQI), according to the report configuration; and
report, at a wireless device, the channel state information (CSI).

18. The wireless communication apparatus of claim 17,
wherein the CSI comprises an indication of a relative offset between frequency domain (FD) bases, or a frequency parameter, or
wherein the frequency parameter is at least one of layer-common, or RS resource specific.

19. A wireless communication apparatus, comprising a processor configured to implement a method, the processor configured to:
transmit, by a network device, a report configuration associated with a reference signal (RS); and
receive, by the network device, a channel state information (CSI), wherein the CSI comprises at least one of an RS indicator, a rank indicator (RI), a precoding matrix indicator (PMI), Doppler information or a channel quality index (CQI), according to the report configuration.

20. The wireless communication apparatus of claim 19,
wherein the CSI comprises an indication of a relative offset between frequency domain (FD) bases, or a frequency parameter, or
wherein the frequency parameter is at least one of layer-common, or RS resource specific.
